(19) United States
(12) Patent Application Publication
(10) Pub. No.: US 2026/0249908 A1
(43) Pub. Date: Aug. 27, 2026

(54) ANGLE SENSING DEVICE AND METHOD OF CONTROLLING THE SAME

(71) Applicant: HL KLEMOVE CORP., Incheon (KR)

(72) Inventors: Hoo-Chang LEE, Incheon (KR); Kyoung-Chul JO, Incheon (KR)

(21) Appl. No.: 19/257,462

(22) Filed: Jul. 2, 2025

(30) Foreign Application Priority Data
Feb. 24, 2025 (KR) 10-2025-0023601

(51) Int. Cl. B62D 15/02

(52) U.S. Cl. CPC B62D 15/0215

(57) ABSTRACT

An angle sensing device includes a steering column supporting a steering wheel of a vehicle and rotating according to rotation of the steering wheel, one or more angle sensors configured to output a signal corresponding to the rotation of the steering column, a rotor connected to the steering column and configured to rotate according to the rotation of the steering column, a proximity sensor disposed to face one surface of the rotor and configured to detect a part of the rotor, and a controller electrically connected to the one or more angle sensors and the proximity sensor, in which the controller is configured to determine a rotation angle of the steering wheel based on an output signal of the one or more angle sensors, and determine a final rotation angle of the steering wheel based on the determined rotation angle and an output signal of the proximity sensor.

### CROSS-REFERENCE TO RELATED APPLICATION

This application claims the priority of Korean Patent Application No. 10-2025-0023601 filed on Feb. 24, 2025, in the Korean Intellectual Property Office, the disclosure of which is incorporated herein by reference in its entirety.

### BACKGROUND

### Field

The present disclosure relates to an angle sensing device and a method of controlling the same.

### Description of the Related Art

A rotation range of a steering wheel varies depending on the purpose, weight, and/or operating convenience of a vehicle, and an angle sensing device utilizes an angle sensor to determine the absolute angle of the steering wheel.

In the related art, technology has been developed to use a vernier algorithm to complementarily apply two angle elements through an angle sensor that includes two different angle elements to ensure a wide rotation range of a steering wheel with precise performance.

However, there is a limit to the maximum rotation range that may be measured using conventionally developed technologies, and it has been impossible to detect a rotation range of a steering wheel greater than the maximum rotation range that may be measured using conventional technologies.

Therefore, technology is needed that may precisely detect a wider rotation range of the steering wheel compared to conventional technologies.

### SUMMARY

One aspect of the present disclosure is to provide an angle sensing device and a method of controlling the same capable of precisely detecting a wider rotation range of a steering wheel compared to the related art.

One aspect of the present disclosure is to provide a novel angle sensing device and a method of controlling the same capable of detecting a rotation range of a steering wheel greater than a maximum rotation range of the steering wheel that may be determined by utilizing a vernier algorithm.

An angle sensing device according to one aspect of the present disclosure includes: a steering column supporting a steering wheel of a vehicle and configured to be rotatable in association with a rotation of the steering wheel; one or more angle sensors configured to output one or more signals corresponding to rotation of the steering column; a rotor operably connected to the steering column and configured to be rotatable in association with the rotation of the steering column; a proximity sensor disposed to face one surface of the rotor and configured to detect a part of the rotor; and a controller electrically connected to the one or more angle sensors and the proximity sensor, in which the controller is configured to determine a first rotation angle of the steering wheel based on the one or more signals output from the one or more angle sensors and determine a second rotation angle of the steering wheel based on an output signal of the proximity sensor and the first rotation angle of the steering wheel determined based on the one or more signals output from the one or more angle sensors.

The rotor may include a first blade having a first length and a second blade having a second length shorter than the first length, and the first blade and the second blade are extended from a main body of the rotor and intersect each other along an outer peripheral surface of the main body of the rotor, and the part of the rotor detected by the proximity sensor is the first blade.

The one or more angle sensors may include a first angle sensor comprising a coil configured to generate an electromagnetic field, a second angle sensor included in the one or more angle sensors and the proximity sensor are disposed on a substrate which is disposed to face the one surface of the rotor, and the proximity sensor is located where the second blade is undetectable by the proximity sensor.

The one or more angle sensors may include a first angle sensor having a first maximum measurable angle and a second angle sensor having a second maximum measurable angle greater than the first maximum measurable angle, and the controller may determine the first rotation angle of the steering wheel using a vernier algorithm based on an output signal of the first angle sensor and an output signal of the second angle sensor.

The controller may obtain a quotient by dividing the first rotation angle of the steering wheel by the first maximum measurable angle of the first angle sensor, obtain a remainder by dividing the obtained quotient by 2, and determine the second rotation angle based on a value obtained by an exclusive OR operation based on the output signal of the proximity sensor and the obtained remainder.

The controller may determine the first rotation angle of the steering wheel determined based on the one or more signals output from the one or more angle sensors as the second rotation angle when the value obtained by the exclusive OR operation is a first value.

The controller may determine, as the second rotation angle, a sum of a third maximum measurable angle, determined based on the output signal of the first angle sensor and the output signal of the second angle sensor, and the first rotation angle of the steering wheel when the value obtained through the exclusive OR operation is a second value different from the first value.

The proximity sensor may include a magnetic proximity sensor, an optical proximity sensor, an inductive proximity sensor, a capacitive proximity sensor, or an ultrasonic proximity sensor.

An angle sensing device according to one aspect of the present disclosure includes: a steering column supporting a steering wheel of a vehicle and configured to rotatable in association with a rotation of the steering wheel; one or more angle sensors configured to output one or more signals corresponding to rotation of the steering column; a rotor operably connected to the steering column and configured to be rotatable in association with the rotation of the steering column, wherein the rotor comprises a first blade having a first length and a second blade having a second length shorter than the first length, and the first blade and the second blade are extended from a main body of the rotor and intersect each other along an outer peripheral surface of the main body of the rotor; a substrate disposed to face the rotor; a proximity sensor disposed on the substrate and configured to detect the first blade of the rotor; and a controller electrically connected to the one or more angle sensors and the proximity sensor, in which the controller is configured to determine a first rotation angle of the steering wheel based on the one or more signals of the one or more angle sensors, and determine a second rotation angle of the steering wheel based on an output signal of the proximity sensor and the first rotation angle of the steering wheel determined based on the one or more signals of the one or more angle sensors.

The one or more angle sensors may include a first angle sensor having a first maximum measurable angle and a second angle sensor having a second maximum measurable angle greater than the first maximum measurable angle, and the controller may determine the first rotation angle of the steering wheel through a vernier algorithm based on an output signal of the first angle sensor and an output signal of the second angle sensor.

The controller may obtain a quotient by dividing the first rotation angle of the steering wheel by the first maximum measurable angle of the first angle sensor, obtain a remainder by dividing the obtained quotient by 2, and determine the second rotation angle based on a value obtained by an exclusive OR operation based on the output signal of the proximity sensor and the obtained remainder.

The controller is configured to determine the first rotation angle of the steering wheel determined based on the one or more signals of the one or more angle sensors as the second rotation angle when the value obtained by the exclusive OR operation is a first value.

The controller may determine, as the second rotation angle, a sum of a third maximum measurable angle, determined based on the output signal of the first angle sensor and the output signal of the second angle sensor, and the first rotation angle of the steering wheel when the value obtained through the exclusive OR operation is a second value different from the first value.

A control method of an angle sensing device according to one aspect of the present disclosure includes: determining a first rotation angle of a steering wheel of a vehicle based on one or more output signals of one or more angle sensors output to correspond to a rotation of the steering wheel; receiving an output signal of a proximity sensor configured to detect a part of a rotor operably connected to a steering column configured to be rotatable in association with the rotation of the steering wheel; and determining a second rotation angle of the steering wheel based on the output signal of the proximity sensor and the first rotation angle of the steering wheel determined based on the one or more output signals of the one or more angle sensors.

The rotor may include a first blade having a first length and a second blade having a second length shorter than the first length, and the first blade and the second blade are extended from a main body of the rotor and intersect each other along an outer peripheral surface of the main body of the rotor, and the part of the rotor detected by the proximity sensor is the first blade.

The proximity sensor may be disposed to face one surface of the rotor at a position where the second blade is undetectable by the proximity sensor.

The one or more angle sensors may include a first angle sensor having a first maximum measurable angle and a second angle sensor having a second maximum measurable angle greater than the first maximum measurable angle, and the determining of the first rotation angle of the steering wheel may include determining the first rotation angle of the steering wheel using a vernier algorithm based on an output signal of the first angle sensor and an output signal of the second angle sensor.

The determining of the second rotation angle of the steering wheel may include obtaining a quotient by dividing the first rotation angle of the steering wheel by the first maximum measurable angle of the first angle sensor, obtaining a remainder by dividing the obtained quotient by 2, and determining the second rotation angle based on a value obtained by an exclusive OR operation based on the output signal of the proximity sensor and the obtained remainder.

The determining of the second rotation angle of the steering wheel may include determining the first rotation angle of the steering wheel determined based on the one or more signals output from the one or more angle sensors as the second rotation angle when the value obtained by the exclusive OR operation is a first value.

The determining of the second rotation angle of the steering wheel may include determining, as the second rotation angle, a sum of a third maximum measurable angle, determined based on the output signal of the first angle sensor and the output signal of the second angle sensor, and the first rotation angle of the steering wheel when the value obtained through the exclusive OR operation is a second value different from the first value.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a steering system according to one embodiment.

FIG. 2 is a diagram illustrating a rotor structure in the steering system according to one embodiment.

FIG. 3 is a block diagram illustrating a control configuration of an angle sensing device included in the steering system according to one embodiment.

FIG. 4 is a flow chart of the operation of the angle sensing device according to one embodiment.

FIG. 5 is a flow chart of the operation of the angle sensing device according to the embodiment of FIG. 4 to determine a final rotation angle of a steering wheel.

FIG. 6 is a graph illustrating an output result according to the operation of the angle sensing device according to one embodiment.

### DETAILED DESCRIPTION OF THE EMBODIMENT

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The present disclosure is to provide a new steering system and method of controlling the same, which complement the related art in which the actual rotation angle of the steering wheel may not be determined when the steering wheel is rotated more than the maximum rotation range of the steering wheel based on the output signal of the angle sensor.

An embodiment of the present disclosure provides a technology for determining the position of a rotor of an angle sensing device of a steering wheel through an additional sensor and based on the determined position, expanding the range of a vernier algorithm by two times to distinguish the rotation range of the steering wheel.

For example, an embodiment of the present disclosure may provide a technology that may identify the position of the rotor by detecting a part of the blade structure through a proximity sensor, which is a non-contact sensor, through a novel blade structure of the rotor of the angle sensing device, and utilize the detected position of the rotor to expand the maximum measurable rotation angle of the steering wheel.

The principle and embodiments of the present disclosure will be described with reference to the attached drawings below.

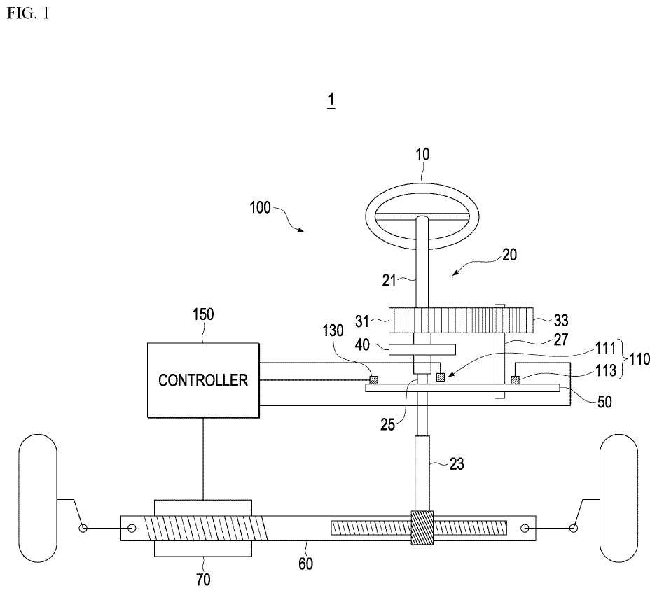

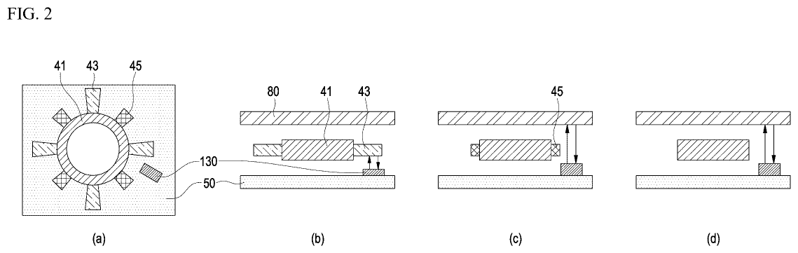

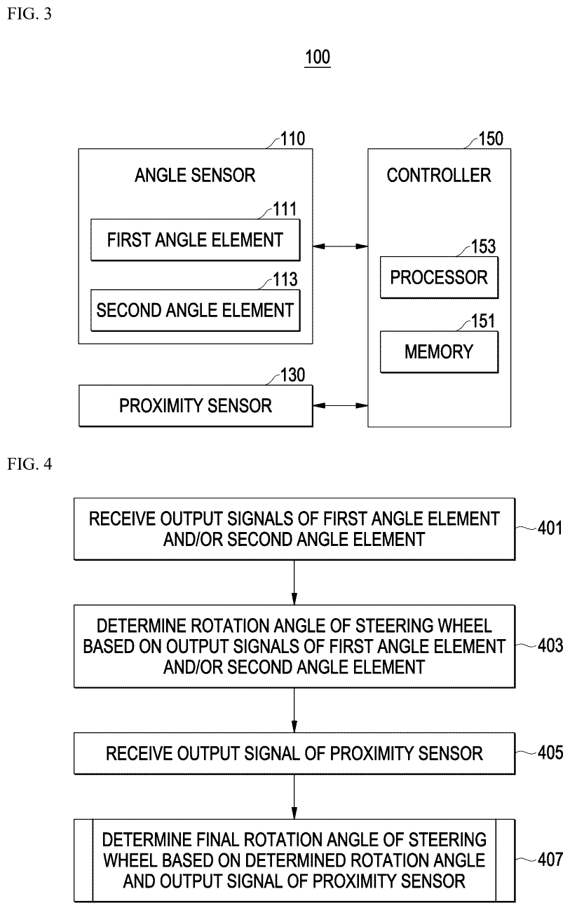

FIG. 1 is a diagram illustrating a steering system according to one embodiment. FIG. 2 is a diagram illustrating a rotor structure in the steering system according to one embodiment. FIG. 3 is a block diagram illustrating a control configuration of an angle sensing device included in a steering system according to one embodiment.

Referring to FIG. 1, the steering system 1 may include a steering wheel 10, a steering column 20, a first gear 31, a second gear 33, a rotor 40, a substrate 50, a rack bar assembly 60, a steering motor 70, an angle sensor 110, a proximity sensor 130, and/or a controller 150. The components illustrated in FIG. 1 do not correspond to essential components of the steering system 1, and at least some of the components illustrated in FIG. 1 may be omitted.

Referring to FIG. 3, the angle sensor 110, the proximity sensor 130, and the controller 150 of the steering system 1 may be referred to as a control configuration of an angle sensing device 100 included in the steering system 1.

The steering wheel 10 may obtain steering input from the driver by rotating the steering wheel clockwise or counterclockwise.

The steering column 20 may support the steering wheel 10 and function as a rotation shaft of the steering wheel 10. The steering column 20 may rotate according to the rotation of the steering wheel 10.

The steering column 20 may include an input shaft 21 and an output shaft 23. The input shaft 21 may be mechanically connected or fixed to the steering wheel 10, and the output shaft 23 may be mechanically connected to the rack bar assembly 60. The input shaft 21 and the output shaft 23 may be axially aligned with each other.

The input shaft 21 and the output shaft 23 may be connected to each other by a torsion bar 25. The torsion bar 25 may be configured to allow the input shaft 21 and the output shaft 23 to rotate relative to each other in response to torque applied to the steering wheel 10.

The first gear 31 is connected to the input shaft 21 corresponding to a part of the steering column 20 and may rotate in conjunction with the input shaft 21.

The second gear 33 may be connected to a sub shaft 27 disposed parallel to the input shaft 21 and may rotate in conjunction with the sub shaft 27. The second gear 33 may rotate in mesh with the first gear 31.

The rotor 40 is connected to the input shaft 21 and may rotate in conjunction with the input shaft 21. The rotor 40 may be disposed on one surface of the first gear 31, for example, the lower surface.

Referring to FIG. 2, the rotor 40 may include a main body 41 and a plurality of first blades 43 having a first length and second blades 43 having a second length shorter than the first length, which extend along the outer peripheral surface of the main body 41. For example, the first blades 43 and the second blades 45 may extend from the main body 41 in a form in which they intersect each other at designated intervals along the outer peripheral surface of the main body 41.

The substrate 50 may be a printed circuit board PCB.

The substrate 50 may be disposed to face one surface of the rotor 40, for example, the lower surface, and may be provided in a fixed manner.

For example, the substrate 50 may be provided in a fixed form. For example, the substrate 50 may be fixed by being connected to the torsion bar 25 having the same axis as the input shaft 21. Accordingly, the substrate 50 may not move with respect to the input shaft 21. In addition, the substrate 50 may be disposed parallel to the lower surface of the rotor 40.

The rack bar assembly 60 may be connected to the steering column 20 and the wheel of the vehicle. The rack bar assembly 60 may perform a linear movement by driving the steering motor 70. The rack bar assembly 60 may change the rotational direction of the rotating shaft of the vehicle wheel to change the traveling direction of the vehicle. For example, the rack bar assembly 60 may move linearly to rotate the rotating axis of the wheel counterclockwise, thereby causing the vehicle to turn to the left. In addition, the rack bar assembly 60 may move linearly to rotate the rotating shaft of the wheel clockwise, thereby causing the vehicle to turn to the right.

The steering motor 70 is connected to the rack bar assembly 60 through a power conversion device and may provide a rotational force for linearly moving the rack bar assembly 60. For example, the steering motor 70 may provide a rotational force for linearly moving the rack bar assembly 60 to the left or right based on a control signal of the controller 150. For example, the rotation of the steering motor 70 may be converted into linear motion through a rack gear and a pinion gear, or the like.

The angle sensor 110 may be one or more and may detect rotation of the steering wheel 10 and/or the steering column 20 by the driver, and output a signal representing the rotation angle of the steering wheel 10 and/or the steering column 20. For example, the angle sensor 110 may transmit an electrical signal representing the rotation angle of the steering wheel 10 and/or the steering column 20 to the controller 150.

The angle sensor 110 may include one or more angle elements, for example, a first angle element 111 and/or a second angle element 113. For example, the maximum rotation ranges measurable by the first angle element 111 and the second angle element 113 may be different from each other.

The first angle element 111 may be an inductive angle element.

The first angle element 111 may convert physical position information according to rotation of the steering wheel 10 and/or steering column 20 into an electrical signal and transmit the converted physical position information to the controller 150.

For example, the first angle element 111 may include a coil (not illustrated) that generates an electromagnetic field and a contactless inductive position sensor application specific integrated circuit (CIPOS ASIC) (not illustrated) that processes a signal induced by the coil and outputs the signal to a controller 150.

Although not illustrated in FIGS. 1 and 2, the coil and the contactless inductive position sensor application specific integrated circuit may be placed on the substrate 50. For example, the coil may be disposed on the substrate 50 in a shape corresponding to the shape of the length of the first blade 43 extending from the main body 41 with the first blade 43 and the second blade 45.

The second angle element 113 may be a Hall-type angle element.

For example, a magnet (not illustrated) that rotates in conjunction with the steering column 20 may be mounted on the steering column 20, and the second angle element 113 may be a Hall integrated circuit IC and may convert a change in the magnetic flux density of the magnet into an electrical signal and transmit the converted electrical signal to the controller 150.

Referring to FIG. 1, the second angle element 113 may be placed on the substrate 50, and also, although not illustrated in FIG. 1, the magnet may be mounted on the lower side of the second gear 33 facing the second angle element 113, for example, on the lower surface of the second gear 33.

The proximity sensor 130 may detect an object within a specified detection range and output an electrical signal.

For example, the proximity sensor 130 may output a binary signal, and for example, output 1 (on signal) when the object is detected and output 0 (off signal) when the object is not detected.

In addition, when the proximity sensor 130 outputs a distance to the object or intensity value, a processor 153 described below may generate 1 indicating that an object has been detected when the distance to the object is within a pre-specified reference distance or the intensity value is within a pre-specified reference intensity, and otherwise generate 2 indicating that the object has not been detected.

For example, the proximity sensor 130 may be any of various conventional proximity sensors, such as a magnetic proximity sensor, an optical proximity sensor, an inductive proximity sensor, a capacitive proximity sensor, or an ultrasonic proximity sensor.

The proximity sensor 130 may be disposed on the substrate 50.

Referring to FIG. 2, the proximity sensor 130 may be mounted on a part of the substrate 50 that may detect the first blade 43 of the rotor 40 according to the rotation of the rotor 40, but may not detect the second blade 45 of the rotor 40.

For example, as illustrated in (b) of FIG. 2, when the rotor 40 rotates, a length portion of the first blade 43 extending from the main body 41 is positioned on the same straight line in the axial direction and the vertical direction, and a part of the end portion of the first blade 43 of the rotor 40 and the proximity sensor 130 may face each other in the axial direction.

Accordingly, the proximity sensor 130 may output a signal indicating that the first blade 43 has been detected. For example, the proximity sensor 130 may output 1 as an output signal, or output the distance to the first blade 43 or the intensity value. When the proximity sensor 130 outputs the distance or intensity value, the processor 153 may identify that the distance value is within a pre-specified reference distance or the intensity value is within a pre-specified reference intensity, and thus 1 may be generated indicating that the first blade 43 has been detected.

In addition, as illustrated in (c) of FIG. 2, when the rotor 40 rotates, the length portion of the second blade 45 extending from the main body 41 is positioned on the same straight line in the axial direction and the vertical direction, but the second blade 45 of the rotor 40 and the proximity sensor 130 may not face each other in the axial direction. In addition, as illustrated in (d) of FIG. 2, when the rotor 40 rotates, the length portions of each of the first blade 43 and the second blade 45 extending from the main body 41 are not positioned on the same straight line in the axial direction and the vertical direction, and the second blade 45 of the rotor 40 and the proximity sensor 130 may not face each other in the axial direction.

Accordingly, the proximity sensor 130 may output a signal indicating that the first blade 43 is not detected or a signal indicating that the housing 80 is detected. For example, the proximity sensor 130 may output 0 as an output signal or output a distance with respect to the housing 80 or intensity value. When the proximity sensor 130 outputs the distance value, it is identified by the processor 153 that the distance value is not within a pre-specified reference distance, or when the proximity sensor 130 outputs an intensity value, it is identified by the processor 153 that the intensity value is not within a pre-specified reference intensity, so that 0 indicating that the first blade 43 is not detected may be generated.

Referring to FIG. 3, the controller 150 may be electrically connected or communicatively connected with the angle sensor 110 and/or the proximity sensor 130.

The controller 150 may receive the output signal of the angle sensor 110 and/or the output signal of the proximity sensor 130.

The controller 150 may determine and output the rotation angle of the steering wheel 10 based on the output signal received from the angle sensor 110.

The controller 150 may determine the rotation angle of the steering wheel 10 based on the output signals of the first angle element 111 and the second angle element 113 through a vernier algorithm or a combination of the vernier algorithm and an angle follower. In this case, for example, a first maximum measurement angle (also called the first maximum rotation range) of the steering wheel 10 that may be determined by the output signal of the first angle element 111 and a second maximum measurement angle (also called the second maximum rotation range) of the steering wheel 10 that may be determined by the output signal of the second angle element 113 may be different.

The vernier algorithm is a method of determining the rotation angle of the steering wheel 10 by combining two signals whose phases of repetition angle (or repetition angles of the signals) are different from each other.

The combination of the vernier algorithm and the angle follower is a method of obtaining the current position of the steering wheel 10 through the vernier algorithm and then determining the rotation angle of the steering wheel 10 through the angle follower. The angle follower is a method of calculating a difference value (delta angle) by comparing the output value of the previous signal and the output value of the current signal for one of the two signals used to determine the rotation angle, and then accumulating and adding the difference value to the existing rotation angle value.

Since the method of determining the rotation angle of the steering wheel 10 using only the vernier algorithm and the combination of the vernier algorithm and the angle follower is the related art, detailed descriptions thereof are omitted.

The controller 150 may determine the final rotation angle of the steering wheel 10 based on the determined rotation angle and the output signal of the proximity sensor 130.

For example, the controller 150 may obtain a quotient from an operation of dividing the determined rotation angle by the first maximum measurement angle of the first angle element 111, and obtain a remainder from an operation of dividing the obtained quotient by 2.

The controller 150 may determine the final rotation angle of the steering wheel 10 based on a value obtained through an exclusive OR operation of the value based on the output signal of the proximity sensor 130 and the obtained remainder.

For example, when the first blade 43 of the rotor 40 is detected, the output signal received by the controller 150 from the proximity sensor 130 may be 1, and when the first blade 43 of the rotor 40 is not detected, the output signal received by the controller 150 from the proximity sensor 130 may be 0.

The controller 150 may determine the determined rotation angle as the final rotation angle of the steering wheel 10 when the value obtained through the exclusive OR operation is 1.

The controller 150 may determine, as the final rotation angle of the steering wheel 10, the sum of a third maximum measurement angle, which may be determined through the vernier algorithm based on the first angle element 111 and the second angle element 113, and the determined rotation angle, when the value obtained through the exclusive OR operation is 0.

The controller 150 may include a memory 151 and/or the processor 153.

The memory 151 may store or remember a program (and/or algorithm) and data for implementing an operation to control the angle sensing device 100.

The memory 151 may store information on the first maximum measurement angle of the first angle element 111 and/or the second maximum measurement angle of the second angle element 113 for the steering wheel 10.

The memory 151 may store third maximum measurement angle information of the steering wheel 10 that may be determined through the vernier algorithm based on the output signal of the first angle element 111 and the output signal of the second angle element 113.

The memory 151 may provide stored programs and data to the processor 153 and store temporary data generated during the operation of the processor 153. For example, the memory 151 may include volatile memory such as Static Random Access Memory (S-RAM) and Dynamic Random Access Memory (D-RAM), and nonvolatile memory such as Read Only Memory (ROM), Erasable Programmable Read Only Memory (EPROM), and flash memory.

The processor 153 may provide a control signal for controlling the operation of components included in the angle sensing device 100.

FIG. 4 is a flow chart of the operation of an angle sensing device 100 (and/or a controller 150) according to one embodiment.

Referring to FIG. 4, the angle sensing device 100 may receive the output signal of the first angle element 111 and/or the second angle element 113 (401).

The angle sensing device 100 may determine the rotation angle of the steering wheel 10 based on the output signal of the first angle element 111 and/or the second angle element 113 (403).

For example, the angle sensing device 100 may determine the rotation angle of the steering wheel 10 through the vernier algorithm based on the output signals of the first angle element 111 and the second angle element 113.

As another example, the angle sensing device 100 may determine the rotation angle of the steering wheel 10 through the combination of the vernier algorithm and the angle follower based on the output signals of the first angle element 111 and the second angle element 113.

The angle sensing device 100 may receive the output signal of the proximity sensor 130 (405).

The angle sensing device 100 may determine the final rotation angle of the steering wheel 10 based on the determined rotation angle and the output signal of the proximity sensor 130 (407).

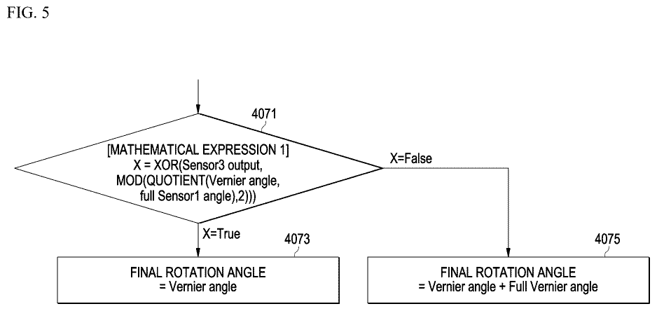

FIG. 5 is a flow chart of an operation in which the angle sensing device 100 (and/or controller 150) according to the embodiment of FIG. 4 determines the final rotation angle of the steering wheel 10.

Referring to FIG. 5, the angle sensing device 100 may determine the X value according to the following Mathematical Expression 1 (4071).

$$X = XOR ( Sensor 3 output , MOD ( QUOTIENT ( Vernier angle , Full Sensor 1 angle ) , 2 ) ) ) \qquad [ Mathematical Expression 1 ]$$

(QUOTIENT( ): a function that calculates the quotient of a division operation, MOD( ): a function that calculates the remainder of a division operation, XOR( ): a function that performs an exclusive OR operation, Vernier angle: a rotation angle (a rotation angle determined according to the above-described 403 operation) determined through a Vernier algorithm, Full Sensor1 angle: a first maximum measurement angle of the first angle element 111, and Sensor 3 output: an output signal (1 or 0) of a proximity sensor (130)

The angle sensing device 100 may determine, as the final rotation angle of the steering wheel 10, the rotation angle (the rotation angle determined according to the operation of 403 described above) determined through the vernier algorithm when X is True, that is, 1 (4073).

The angle sensing device 100 may determine, as the final rotation angle of the steering wheel 10, the sum of the rotation angle (the rotation angle determined according to the operation of 403 described above) determined through the vernier algorithm and the third maximum measurement angle (Full Vernier angle) that may be determined through the vernier algorithm when X is False, that is, 0 (4075).

The final rotation angle determination of the steering wheel 10 according to the embodiment of FIG. 5 described above may be applied when the number of magnetic poles generated by the coils disposed corresponding to the first blade 43 and the second blade 45 of the second angle element 111, that is, the number of rotor poles (order of rotor poles), is even.

In addition, a fourth maximum measurement angle (Extended Vernier angle) of the steering wheel 10 that may be determined according to the operation of 4075 in the embodiment of FIG. 5 described above may be as illustrated in the following Mathematical Expression 2.

$$Extended Vernier angle = Vernier angle + NOT ( B ) * Full Vernier angle \qquad [ Mathematical Expression 2 ]$$

(B=XOR(Sensor3 output, A), A=MOD(QUOTIENT(Vernier angle, Full Sensor1 output angle),2), Full Vernier angle: maximum measurement angle that may be determined through the vernier algorithm)

Meanwhile, the final rotation angle determination of the steering wheel 10 according to the embodiments described above may be performed when the number of magnetic poles generated by the coils disposed corresponding to the first blade 43 and the second blade 45 of the second angle element 111, that is, the number of rotor poles (order of rotor poles), is even.

For example, after the operation of 403 described above, the angle sensing device 100 may immediately perform the operation of 407 when the number of magnetic poles generated by the coils disposed corresponding to the first blade 43 and the second blade 45 of the second angle element 111 is even.

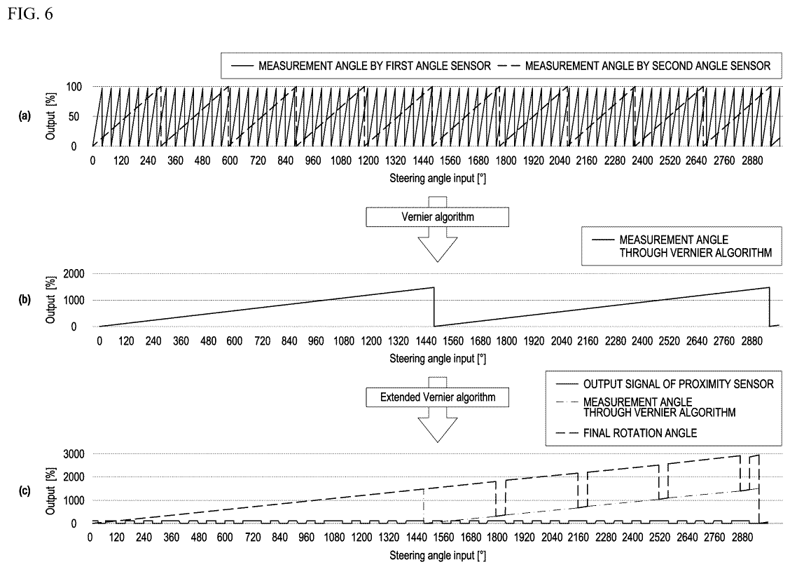

In addition, the final rotation angle determination of the steering wheel 10 according to the above-described embodiments may also be applied even when the number of magnetic poles generated by the coils disposed corresponding to the first blade 43 and the second blade 45 of the second angle element 111, that is, the number of rotor poles (order of rotor poles) is odd. For example, when the number of rotor poles is odd, the final rotation angle determination of the steering wheel 10 may be performed in a section other than some specific sections as illustrated in FIG. 6, and the final rotation angle determination of the steering wheel 10 may be reserved for some specific sections.

FIG. 6 is a graph illustrating an output result according to the operation of the angle sensing device 100 (and/or a controller 150) according to one embodiment.

FIG. 6 is a diagram illustrating an output result according to the operation of the angle sensing device 100 when the number of magnetic poles generated by the coils disposed corresponding to the first blade 43 and the second blade 45 of the second angle element 111, that is, the number of rotor poles (order of rotor poles) is odd.

Referring to (a) of FIG. 6, the first maximum measurement angle of the steering wheel 10 that may be determined through the output signal of the first angle element 111 may be 40°, and the second maximum measurement angle of the steering wheel 10 that may be determined through the output signal of the second angle element 113 may be 296°.

The controller 150 may determine the rotation angle of the steering wheel 10 up to the third maximum measurement angle of about 1480°, as illustrated in (b) of FIG. 6, through the vernier algorithm (or a combination of the vernier algorithm and the angle follower), based on the fact that the first maximum measurement angle of the first angle element 111 is 40° and the second maximum measurement angle of the second angle element 113 is 296°.

The controller 150 may determine the rotation angle of the steering wheel 10 as the final rotation angle up to the fourth maximum measurement angle of about 2960°, as illustrated in (c) of FIG. 6, based on the output signal (0 or 1) of the proximity sensor for each angle of the steering wheel 10 and the measurement angle of the steering wheel 10 determined through the vernier algorithm as illustrated in (b) of FIG. 6, and output the result.

However, referring to (c) of FIG. 6, it may be seen that the final rotation angle may not be determined in a certain section based on 1800°, a certain section based on 2160°, a certain section based on 2520°, and a certain section based on 2880° of the measurement angle of the steering wheel 10. Accordingly, the controller 150 may reserve the determination of the final rotation angle for a pre-designated section.

The controller 150 determines the final rotation angle based on the output signal (0 or 1) of the proximity sensor for each angle of the steering wheel 10 and the measurement angle of the steering wheel 10 determined through the vernier algorithm, which may be called an extended vernier algorithm.

Meanwhile, the vehicle in the above-described embodiments may include various means of transportation, such as a two-wheeled vehicle, a three-wheeled vehicle, a four-wheeled vehicle, and/or a mobility device (for example, an electric bicycle, an electric scooter, and/or a smart mobility device, or the like).

The angle sensing device 100 and the method of controlling the same according to the above-described embodiments may provide a new technology capable of detecting the rotation range of a steering wheel 10 greater than the maximum rotation range of the steering wheel 10 that may be determined by utilizing the vernier algorithm.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. An angle sensing device comprising:
a steering column supporting a steering wheel of a vehicle and configured to be rotatable in association with a rotation of the steering wheel;
one or more angle sensors configured to output one or more signals corresponding to rotation of the steering column;
a rotor operably connected to the steering column and configured to be rotatable in association with the rotation of the steering column;
a proximity sensor disposed to face one surface of the rotor and configured to detect a part of the rotor; and
a controller electrically connected to the one or more angle sensors and the proximity sensor,
wherein the controller is configured to determine a first rotation angle of the steering wheel based on the one or more signals output from the one or more angle sensors and determine a second rotation angle of the steering wheel based on an output signal of the proximity sensor and the first rotation angle of the steering wheel determined based on the one or more signals output from the one or more angle sensors.

2. The angle sensing device according to claim 1, wherein:
the rotor includes a first blade having a first length and a second blade having a second length shorter than the first length, and the first blade and the second blade are extended from a main body of the rotor and intersect each other along an outer peripheral surface of the main body of the rotor, and
the part of the rotor detected by the proximity sensor is the first blade.

3. The angle sensing device according to claim 2, wherein:
the one or more angle sensors includes a first angle sensor comprising a coil configured to generate an electromagnetic field,
a second angle sensor included in the one or more angle sensors and the proximity sensor are disposed on a substrate which is disposed to face the one surface of the rotor, and
the proximity sensor is located where the second blade is undetectable by the proximity sensor.

4. The angle sensing device according to claim 1, wherein:
the one or more angle sensors include a first angle sensor having a first maximum measurable angle and a second angle sensor having a second maximum measurable angle greater than the first maximum measurable angle, and
the controller is configured to determine the first rotation angle of the steering wheel using a vernier algorithm based on an output signal of the first angle sensor and an output signal of the second angle sensor.

5. The angle sensing device according to claim 4, wherein the controller is configured to:
obtain a quotient by dividing the first rotation angle of the steering wheel by the first maximum measurable angle of the first angle sensor,
obtain a remainder by dividing the obtained quotient by 2, and
determine the second rotation angle based on a value obtained by an exclusive OR operation based on the output signal of the proximity sensor and the obtained remainder.

6. The angle sensing device according to claim 5, wherein the controller is configured to determine the first rotation angle of the steering wheel determined based on the one or more signals output from the one or more angle sensors as the second rotation angle when the value obtained by the exclusive OR operation is a first value.

7. The angle sensing device according to claim 6, wherein the controller is configured to determine, as the second rotation angle, a sum of a third maximum measurable angle, determined based on the output signal of the first angle sensor and the output signal of the second angle sensor, and the first rotation angle of the steering wheel when the value obtained through the exclusive OR operation is a second value different from the first value.

8. The angle sensing device according to claim 1, wherein the proximity sensor includes a magnetic proximity sensor, an optical proximity sensor, an inductive proximity sensor, a capacitive proximity sensor, or an ultrasonic proximity sensor.

9. An angle sensing device comprising:
a steering column supporting a steering wheel of a vehicle and configured to rotatable in association with a rotation of the steering wheel;
one or more angle sensors configured to output one or more signals corresponding to rotation of the steering column;
a rotor operably connected to the steering column and configured to be rotatable in association with the rotation of the steering column, wherein the rotor comprises a first blade having a first length and a second blade having a second length shorter than the first length, and the first blade and the second blade are extended from a main body of the rotor and intersect each other along an outer peripheral surface of the main body of the rotor;
a substrate disposed to face the rotor;
a proximity sensor disposed on the substrate and configured to detect the first blade of the rotor; and
a controller electrically connected to the one or more angle sensors and the proximity sensor,
wherein the controller is configured to determine a first rotation angle of the steering wheel based on the one or more signals of the one or more angle sensors, and determine a second rotation angle of the steering wheel based on an output signal of the proximity sensor and the first rotation angle of the steering wheel determined based on the one or more signals of the one or more angle sensors.

10. The angle sensing device according to claim 9, wherein:
the one or more angle sensors include a first angle sensor having a first maximum measurable angle and a second angle sensor having a second maximum measurable angle greater than the first maximum measurable angle, and
the controller is configured to determine the first rotation angle of the steering wheel through a vernier algorithm based on an output signal of the first angle sensor and an output signal of the second angle sensor.

11. The angle sensing device according to claim 10, wherein the controller is configured to:
obtain a quotient by dividing the first rotation angle of the steering wheel by the first maximum measurable angle of the first angle sensor,
obtain a remainder by dividing the obtained quotient by 2, and
determine the second rotation angle based on a value obtained by an exclusive OR operation based on the output signal of the proximity sensor and the obtained remainder.

12. The angle sensing device according to claim 11, wherein the controller is configured to determine the first rotation angle of the steering wheel determined based on the one or more signals of the one or more angle sensors as the second rotation angle when the value obtained by the exclusive OR operation is a first value.

13. The angle sensing device according to claim 12, wherein the controller is configured to determine, as the second rotation angle, a sum of a third maximum measurable angle, determined based on the output signal of the first angle sensor and the output signal of the second angle sensor, and the first rotation angle of the steering wheel when the value obtained through the exclusive OR operation is a second value different from the first value.

14. A computerized method comprising:
determining a first rotation angle of a steering wheel of a vehicle based on one or more output signals of one or more angle sensors output to correspond to a rotation of the steering wheel;
receiving an output signal of a proximity sensor configured to detect a part of a rotor operably connected to a steering column configured to be rotatable in association with the rotation of the steering wheel; and
determining a second rotation angle of the steering wheel based on the output signal of the proximity sensor and the first rotation angle of the steering wheel determined based on the one or more output signals of the one or more angle sensors.

15. The method according to claim 14, wherein:
the rotor includes a first blade having a first length and a second blade having a second length shorter than the first length, and the first blade and the second blade are extended from a main body of the rotor and intersect each other along an outer peripheral surface of the main body of the rotor, and
the part of the rotor detected by the proximity sensor is the first blade.

16. The method according to claim 15, wherein the proximity sensor is disposed to face one surface of the rotor at a position where the second blade is undetectable by the proximity sensor.

17. The method according to claim 14, wherein:
the one or more angle sensors include a first angle sensor having a first maximum measurable angle and a second angle sensor having a second maximum measurable angle greater than the first maximum measurable angle, and
the determining of the first rotation angle of the steering wheel includes determining the first rotation angle of the steering wheel using a vernier algorithm based on an output signal of the first angle sensor and an output signal of the second angle sensor.

18. The method according to claim 17, wherein the determining of the second rotation angle of the steering wheel includes
obtaining a quotient by dividing the first rotation angle of the steering wheel by the first maximum measurable angle of the first angle sensor,
obtaining a remainder by dividing the obtained quotient by 2, and
determining the second rotation angle based on a value obtained by an exclusive OR operation based on the output signal of the proximity sensor and the obtained remainder.

19. The method according to claim 18, wherein the determining of the second rotation angle of the steering wheel includes determining the first rotation angle of the steering wheel determined based on the one or more signals output from the one or more angle sensors as the second rotation angle when the value obtained by the exclusive OR operation is a first value.

20. The method according to claim 19, wherein the determining of the second rotation angle of the steering wheel includes determining, as the second rotation angle, a sum of a third maximum measurable angle, determined based on the output signal of the first angle sensor and the output signal of the second angle sensor, and the first rotation angle of the steering wheel when the value obtained through the exclusive OR operation is a second value different from the first value.
